(19) United States
(12) Patent Application Publication
(10) Pub. No.: US 2004/0054934 A1
(43) Pub. Date: Mar. 18, 2004

(54) Method for authenticating a first object to at least one further object, especially the vehicle to at least one key

(76) Inventors: Ulrich Emmerling, Kelheim (DE); Matthias Huschenbett, Regensburg (DE); John Martin Evans, Regensburg (GB); Torsten Thiel, Neumarkt (DE)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/603,209

(22) Filed: Jun. 25, 2003

(30) Foreign Application Priority Data
Jul. 4, 2002 (DE) 102 30 098.4

(51) Int. Cl. H04L 9/32

(52) U.S. Cl. 713/202; 713/183

(57) ABSTRACT

A method of authenticating a first object to at least one further object, especially a vehicle to a key, is disclosed in which information is transmitted unidirectionally between the first object and at least one further object, the computation result is calculated from parts of the transmitted information in the receiving object in each case, the calculated computation result is compared with a computation result transmitted with the information, and only if these match is the sending object viewed as authenticated and the computation result declared invalid for further transmissions.

### PRIORITY

This application claims foreign priority of the German application DE 102 30 098.4 filed on Jul. 4, 2002.

### TECHNICAL FIELD OF THE INVENTION

The invention relates to a method of authenticating a first object to at least one further object. These types of method are used for example in vehicle technology, in which case a vehicle is to be authenticated to a key or to an ID generator.

### BACKGROUND OF THE INVENTION

This authentication, that is the evidence of authorization, is nominally undertaken using bidirectional, encrypted communication between the vehicle or the base station located in it, for example a control unit and the key carried by a person.

In this case the requirements in relation to unauthorized access are always greater, so that listening in on and decrypting the authentication must also be taken into account.

To increase security against unauthorized access, DE 19516992C1 for example, suggests a bidirectional method in which a key or a transponder initially sends invalid data to a lock or a control unit and a request signal with a memory address for the transponder is then sent back. The code word stored in the transponder under the memory address is read out and sent to the lock. There the code word is compared with a required code word, and if they match a vehicle immobiliser is deactivated. Subsequently address and/or code word are recalculated in the lock and set in the transponder for the subsequent release cycle so that an alternating code is produced.

However, with the rapid advance of eavesdropping and decryption technology, this type of method for access authorization (including authentication) only offers protection under some conditions or requires ever greater design effort in order to guarantee sufficient protection.

With passive access systems in particular, for example in vehicle technology, in which the vehicle can be locked and unlocked by a portable ID generator or key without (active) activation of a key button (with possible simultaneous activation and deactivation of the immobiliser or anti-theft alarm), new problems arise.

For example a key that was left inside the vehicle by mistake or placed there intentionally can result in an unauthorized person obtaining access when communication is initiated, for example by pulling the door handle, between e vehicle an intentionally authorized person with a valid key. If for example an unauthorized person pulls the door handle a base station located in the vehicle usually asks whether there is a valid key in the vicinity.

Even with inductive transmission with the appropriate inductive antennas which are normally positioned in the area of the door lock the received field cannot for physical reasons be prevented from extending some way into the interior of the vehicle. When the key is located in a particular place in the vehicle communication would then take place with this key once initiated so that an unauthorized person could obtain access to the vehicle.

To prevent a key located in the vehicle being recognized as valid despite the fact that a key is also being carried, it is necessary to mark keys of this type as at least temporarily invalid or deactivated.

This marking is normally undertaken using bidirectional communication and storage of the received information in the control unit, in which case at least the communication from the key in the direction of the control unit is conducted over an RF link. Should the deactivated key or keys be reactivated this marking will be cancelled again.

This type of authentication is however expensive and is still susceptible, in particular because of the extensive RF link, to expensive eavesdropping attempts.

### SUMMARY OF THE INVENTION

The present invention is based on the object of creating a method of authenticating a first object to at least one further object, especially a vehicle, to at least one key, that provides increased protection against unauthorized authentication and is simple to implement.

This object can be achieved by a method for authenticating a first object to at least one further object, in particular a vehicle to a key, comprising the steps of:

a) transmitting an item of information unidirectionally between the first object and the at least one further object,

b) calculating a computation result in the relevant receiving object from parts of the transmitted information,

c) comparing the calculated computation result with a computation result transferred with the information,

d) only if there is a match authenticating the sending object, and

e) declaring the computation result as invalid for further transmissions.

The information can be sent from a vehicle as a first object and received by a key as at least one further object. As parts of the information, a random number and an incremental or decrementable item of data which is stored in at least one further object if it matches the computation result, can be transferred, and after each transmission of the information, regardless of a successful receipt, the item of data can be incremented or decremented before new information is sent. A counter state or item of time data can be transferred as the item of data that can be incremented. The result can be only calculated when the transferred item of data is greater than the stored item of data. When the transferred result and the calculated result match, the incrementable item of data can be increased so that the transferred result becomes invalid. The result can be computed in at least one further object using a cryptological computation algorithm known there and a code word.

Using the method in accordance with the invention keys are not identified in the control unit as activated or deactivated, but by a unidirectional communication in the key itself. Advantageously this communication only takes place via an inductive LF link (with a frequency of for example 10 to 200 kHz) with a short range, for example less than 2 m. Trans mission in only one direction and also using an LF link means that increased security against eavesdropping can be advantageously achieved.

In addition, by using the method in accordance with the invention, authentication is cryptologically secured, despite the unidirectional transmission, by the fact that a result is computed in the key from the data transferred and is compared with a result transmitted.

Security here can be increased by a calculation process that cannot be decrypted or can only be decrypted with difficulty (computation algorithm), such as calculation in accordance with the hash method, with a code word or a password.

In addition, in accordance with the invention, the computation result transferred depends on an incrementable or decrementable item of data such as the incrementation or decrementation of a counter state or a time specification so that a temporarily transmitted computation result automatically becomes invalid. In this way security against unauthorized authentication is increased further since even eavesdropping on a transmission and thereby knowledge of the computation result does not give any insights into a (new) computation result that is valid from then on.

The method in accordance with the invention can be used in an embodiment of the invention to authenticate a first at least temporarily stationary object, for example vehicle to at least one further mobile object, for example a vehicle key. Thus keys that have been deactivated, since they are left in a locked vehicle or for other reasons are to be regarded as at least temporally invalid, can be reactivated in accordance with the inventive method quickly and easily with a high degree of eavesdropping protection and additional cryptological security, i.e. the vehicle can be authenticated to such a key.

Since the cryptological security is undertaken by a calculation in the key and the computation result transferred in each case is invalid for future authentication, unidirectional transmission can occur advantageously in a simple to implement plain text.

Of course the method in accordance with the invention is not only restricted to activating previously deactivated keys, for example when the vehicle is locked or the security deactivated by a valid active key.

The method in accordance with the invention can also be applied to authentication of a key to a vehicle. It is also conceivable to use the authentication not only for activation of keys left in the vehicle and deactivated, but for example to precede them with any (subsequent) mostly bidirectional communication between the objects, for example to trigger desired functions such as the locking or unlocking of the central locking, deactivation or activation of the vehicle immobiliser etc.

The invention will be explained in more detail below using an exemplary embodiment shown in the drawing.

### BRIEF DESCRIPTION OF THE DRAWING

The Figure shows:

FIG. 1A flowchart of the method in accordance with the invention.

### DETAILED DESCRIPTION OF THE PREFERRED EMBODIMENTS

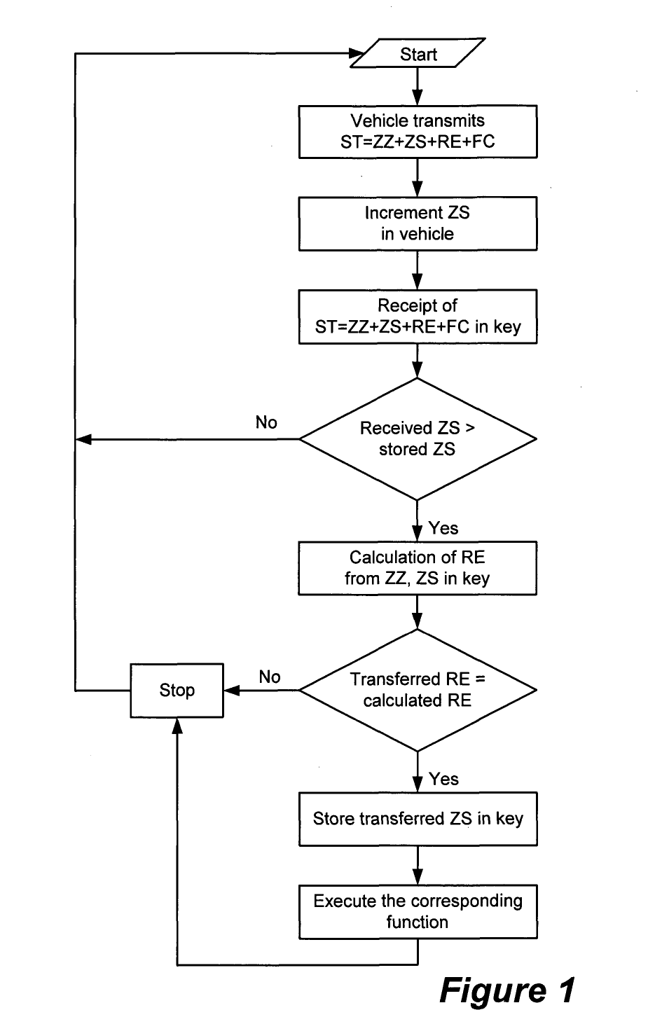

As shown as a flowchart in FIG. 1, the method in accordance with the invention begins with a start, i.e. and initiation, as would typically occur when an operator pulls a door handle and the detection of a valid (active) key by the vehicle or by the control unit located in the vehicle. With this type of opening an activation signal (enable) can be transmitted for deactivated (disabled) keys.

It is however also conceivable to introduce such a start in another way, for example by the operator themselves or by activation of a corresponding key or button on or in the vehicle or depending on another action to be executed by the control unit such as switching on the interior lighting etc.

Once the process has started the control unit or the base station in the vehicle sends out the appropriate information in the form of a send telegram (ST) which consists of a random number (ZZ), an incrementable item of data such as a counter state (ZS), a result of the computation (RE) and a function code (FC).

A new random number is determined in the control unit for each transmission and the counter state of a counter present in the control unit is incremented or decremented by 1 for example after each transmission. Of course it is also possible, instead of a counter state, to transmit any time specification of a clock running forwards or backwards in the control unit so that after each transmission, instead of an ongoing (forwards or backwards) counter state a new time specification is transferred.

In the deactivated key the send a telegram, which is advantageously transmitted via a limited-range inductive antenna directed into the interior, is received, in which case the key receives at intervals, or as a result of the low power consumption for an LF receiver, can even receive permanently.

To advantageously avoid unnecessary calculations in the key or the logic electronics contained in it, a subsequent check can be made to as to whether the received counter state is greater (in the case of an agreed decrementation correspondingly less) than the counter state stored in the key. The counter state stored in a register in the key typically originates here from a preceding authentication or even from a one-off synchronisation of the key with the control unit in the form of a learning process or an initialization.

If the received counter state is greater (or in the case of a downwards counter in the control unit less) than the stored counter state, the result from the transferred counter state, from the transferred random number and possibly from further information included in the transferred function code, is computed in the key.

On the other hand, if the received counter state is less than or equal to (or with upwards counter instead of a downwards counter equal to or greater than) the stored counter state no computation is performed in the key and the key continues to wait for a new send telegram.

For the calculation a computation result is calculated using a non-reversible (encryption) calculation algorithm known in the key, such as example a hash algorithm with which a code word already known in the key calculates the result and subsequently compares it with the transferred calculation result.

If the computation result transferred does not match the one calculated, no further actions are undertaken in the key (Stop), so that the key again waits to receive a new send telegram.

If the calculation results match, the transferred counter state (or the time specification) is typically stored in a register, a flash memory or similar in the key and the key is activated (enabled) by an action in key, for example by changing a register value or the contents of a memory address, switching a circuit etc.

With a key activated in this way actions such as unlocking or locking the central locking and deactivating or activating the vehicle immobiliser, “activating or deactivating the vehicle security etc. can be activated for transmission procedures known for passive access systems after authorization or authentication has taken place.

Of course the method in accordance with the invention is not limited to the exemplary embodiment illustrated, but can be transferred to all areas in which an object is to be authenticated to a further object in a simple way with high security against errors and unauthorized attacks.

Thus the method in accordance with the invention can also be used for house doors, garage doors, entry to secure areas and similar applications.

1. Method for authenticating a first object to at least one further object, in particular a vehicle to a key, comprising the steps of:
a) transmitting an item of information unidirectionally between the first object and the at least one further object,
b) calculating a computation result in the relevant receiving object from parts of the transmitted information,
c) comparing the calculated computation result with a computation result transferred with the information, and
d) if there is a match authenticating the vehicle, declaring the computation result as invalid for further transmissions.

2. Method in accordance with claim 1, wherein the information is sent from a vehicle as a first object and received by a key as at least one further object.

3. Method in accordance with claim 1, wherein as parts of the information, a random number and an incremental or decrementable item of data which is stored in at least one further object if it matches the computation result, is transferred, and after each transmission of the information, regardless of a successful receipt, the item of data is incremented or decremented before new information is sent.

4. Method in accordance with claim 2, wherein as parts of the information, a random number and an incremental or decrementable item of data which is stored in at least one further object if it matches the computation result, is transferred, and that after each transmission of the information, regardless of a successful receipt, the item of data is incremented or decremented before new information is sent.

5. Method in accordance with claim 1, wherein a counter state or item of time data is transferred as the item of data that can be incremented.

6. Method in accordance with claim 2, wherein a counter state or item of time data is transferred as the item of data that can be incremented.

7. Method in accordance with claim 5, wherein the result is only calculated when the transferred item of data is greater than the stored item of data.

8. Method in accordance with claim 5, wherein when the transferred result and the calculated result match, the incrementable item of data is increased so that the transferred result becomes invalid.

9. Method in accordance with claim 7, wherein when the transferred result and the calculated result match, the incrementable item of data is increased so that the transferred result becomes invalid.

10. Method in accordance with claim 1, wherein the result is computed in at least one further object using a cryptological computation algorithm known there and a code word.

11. Method for authenticating a vehicle to at a key comprising the steps of:
a) transmitting an item of information unidirectionally between the vehicle and the key,
b) calculating a computation result in the key from parts of the transmitted information,
c) comparing the calculated computation result with a computation result transferred with the information, and
d) if there is a match authenticating the vehicle, declaring the computation result as invalid for further transmissions.

12. Method in accordance with claim 11, wherein as parts of the information, a random number and an incremental or decrementable item of data which is stored in the key if it matches the computation result, is transferred, and after each transmission of the information, regardless of a successful receipt, the item of data is incremented or decremented before new information is sent.

13. Method in accordance with claim 11, wherein a counter state or item of time data is transferred as the item of data that can be incremented.

14. Method in accordance with claim 13, wherein the result is only calculated when the transferred item of data is greater than the stored item of data.

15. Method in accordance with claim 13, wherein when the transferred result and the calculated result match, the incrementable item of data is increased so that the transferred result becomes invalid.

16. Method in accordance with claim 14, wherein when the transferred result and the calculated result match, the incrementable item of data is increased so that the transferred result becomes invalid.

17. Method in accordance with claim 11, wherein the result is computed in the key using a cryptological computation algorithm known there and a code word.
